(19) United States
(12) Patent Application Publication
(10) Pub. No.: US 2022/0189110 A1
(43) Pub. Date: Jun. 16, 2022

(54) SYSTEM AND METHOD FOR ADAPTIVELY CONSTRUCTING A THREE-DIMENSIONAL FACIAL MODEL BASED ON TWO OR MORE INPUTS OF A TWO-DIMENSIONAL FACIAL IMAGE

(71) Applicant: NEC Corporation, Minato-ku, Tokyo (JP)

(72) Inventors: Weng Sing TANG, Singapore (SG); Tien Hiong LEE, Singapore (SG); Xin QU, Singapore (SG); Iskandar GOH, Singapore (SG); Luke Christopher Boon Kiat SEOW, Singapore (SG)

(73) Assignee: NEC Corporation, Minato-ku, Tokyo (JP)

(21) Appl. No.: 17/441,817

(22) PCT Filed: Mar. 27, 2020
(86) PCT No.: PCT/JP2020/015256

§ 371 Date: Sep. 22, 2021

(30) Foreign Application Priority Data
Mar. 29, 2019 (SG) 10201902889V

(51) Int. Cl. G06T 17/00; G06T 7/55; G06V 40/16; G06V 40/40

(52) U.S. Cl. CPC G06T 17/00; G06V 40/45; G06V 40/166; G06T 7/55

(57) ABSTRACT

A system and a method for adaptively constructing a three-dimensional (3D) facial model based on two or more inputs of a two-dimensional (2D) facial image are disclosed. The server includes at least one processor and at least one memory including computer program code. The at least one memory and the computer program code are configured to, with the at least one processor, cause the server at least to receive, from an input capturing device, the two or more inputs of the 2D facial image, the two or more inputs being captured at different distances from the image capturing device, determine depth information relating to at least a point of each of the two or more inputs of the 2D facial image and construct the 3D facial model in response to the determination of the depth information.

### TECHNICAL FIELD

The example embodiments relate broadly, but not exclusively, to system and method for face liveness detection. Specifically, they relate to a system and method for adaptively constructing a three-dimensional facial model based on two or more inputs of a two-dimensional facial image.

### BACKGROUND ART

Face recognition technology is rapidly growing in popularity, and has been widely used on mobile devices as a means of biometric authentication for unlocking devices. However, the growing popularity of facial recognition technology and its adoption as an authentication method comes with a host of drawbacks and challenges. Passwords and personal identification numbers (PINs) can be stolen and compromised. The same can be said for a person's face. An attacker can masquerade as an authenticated user by falsifying face biometric data of the targeted user (also known as face spoofing) to gain access to a device/service. Face spoofing can be relatively straightforward and does not demand additional technical skills from the spoofer other than to simply download a photograph (preferably high-resolution) of the targeted user from publicly available sources (e.g. social networking services), optionally printing the photograph of the targeted user on paper, and presenting the photograph of the targeted person in front of an image sensor of the device during the authentication process.

There is therefore a need for effective liveness detection mechanisms in authentication methods relying on face recognition technology, to ensure robust and effective authentication. Face recognition algorithms, augmented with effective liveness detection techniques, can introduce additional layers of defense against face spoofing and can improve the security and reliability of the authentication system. However, existing liveness detection mechanisms are often not robust enough and can be misled and/or bypassed with little effort from adversaries. For example, an adversary can masquerade as an authenticated user using a recorded video of the user on a high resolution display. The adversary can replay the recorded video in front of a camera of a mobile device to gain illegitimate access to the device. Such replay attacks can be easily carried out with videos obtained from publicly available sources (e.g. social networking services).

Therefore, authentication methods relying on existing face recognition technology can be easily circumvented and are often vulnerable to attacks by adversaries, particularly if it takes little effort for adversaries to acquire and reproduce images and/or videos of the targeted person (e.g. a public figure). Nevertheless, authentication methods relying on face recognition technology can still provide a higher degree of convenience and better security compared to conventional forms of authentication, such as the use of passwords or personal identification numbers. Authentication methods relying on face recognition technology are also increasingly used in more ways on the mobile devices (e.g. as means to authorize payments facilitated by the devices or as an authentication means to gain access sensitive data, applications and/or services).

Accordingly, what is needed is system and method for adaptively constructing a three-dimensional facial model based on two or more inputs of a two-dimensional facial image that seek to address one or more of the above-mentioned problems. Furthermore, other desirable features and characteristics will become apparent from the subsequent detailed description and the appended claims, taken in conjunction with the accompanying drawings and this background of the disclosure.

### SUMMARY OF INVENTION

An aspect provides a server for adaptively constructing a three-dimensional (3D) facial model based on two or more inputs of a two-dimensional (2D) facial image. The server includes at least one processor and at least one memory including computer program code. The at least one memory and the computer program code are configured to, with the at least one processor, cause the server at least to receive, from an input capturing device, the two or more inputs of the 2D facial image, the two or more inputs being captured at different distances from the image capturing device, determine depth information relating to at least a point of each of the two or more inputs of the 2D facial image, and construct the 3D facial model in response to the determination of the depth information.

Another aspect provides a method for adaptively constructing a three-dimensional (3D) facial model based on two or more inputs of a two-dimensional (2D) facial image. The method includes receiving, from an input capturing device, the two or more inputs of the 2D facial image, the two or more inputs being captured at different distances from the image capturing device, determining depth information relating to at least a point of each of the two or more inputs of the 2D facial image and constructing the 3D facial model in response to the determination of the depth information.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1 shows a schematic diagram of a system for adaptively constructing a three-dimensional facial model based on two or more inputs of a two-dimensional facial image, in accordance with embodiments of the disclosure.

FIG. 2 shows a flowchart illustrating a method for adaptively constructing a three-dimensional facial model based on two or more inputs of a two-dimensional facial image, in accordance with embodiments of the disclosure.

FIG. 3 shows a sequence diagram for determining an authenticity of a facial image, in accordance with embodiments of the invention.

FIG. 4 shows a sequence diagram for obtaining motion sensor information and image sensor information, in accordance with embodiments of the invention.

FIG. 5 shows exemplary screenshots seen by a user during a liveness challenge, in accordance with embodiments of the invention.

FIG. 6 shows an outline of facial landmark points associated with a two-dimensional facial image, in accordance with embodiments of the invention.

FIGS. 7A to 7C show sequence diagrams for constructing a 3D facial model, in accordance with embodiments of the invention.

FIG. 8 shows a schematic diagram of a computing device used to realise the system of FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DESCRIPTION OF EMBODIMENTS

### Overview

As biometric authentication systems based on facial recognition become more widely used in real-world applications, biometric spoof (also known as face spoofing or presentation attacks) become a larger threat. Face spoofing can include print attack, replay attack and 3D masks. Current approaches on anti-face spoofing techniques in facial recognition systems seek to recognise such attacks and are generally categorized into a few areas, i.e. in image quality, contextual information and local texture analysis. Specifically, current approaches have been mainly focused on analysis and differentiation of local texture pattern in luminance components between real and fake images. However, current approaches are typically based on a single image, and such approaches are limited to use of local features (or features specific to a single image) to determine a spoofed facial image. Moreover, existing image sensors typically do not have the capability of generating information sufficient to determine the liveness of a face as effectively as a human being. It can be appreciated that liveness of a face includes determining whether or not the information relates to a 3D image. This is because global contextual information, such as depth information, is often lost in a 2D facial image captured by an image sensor (or an image capturing device), and the local information in the single facial image of the person is generally insufficient to provide an accurate, reliable assessment of the liveness of the face.

The example embodiments provide a server and a method for adaptively constructing a three-dimensional (3D) facial model based on two or more inputs of a two-dimensional (2D) facial image. Information relating to the three-dimensional (3D) facial model can be used to determine at least one parameter to detect authenticity and liveness of the facial image, using artificial neural networks. Particularly, the neural network can be a deep neural network configured to detect liveness of a face and to ascertain real presence of an authorised user. An artificial neural network including the server and method as claimed can advantageously provide a high assurance and reliable solution that is capable of effectively countering a plethora of face spoofing techniques. It is to be appreciated that rule based learning and regression model may be used in other embodiments to provide the high assurance and reliable solution.

In the various example embodiments, the method for adaptively constructing the 3D facial model can include (i) receiving, from an input capturing device (e.g. a device including one or more image sensors), two or more inputs of the 2D facial image, the two or more inputs being captured at different distances from the image capturing device, (ii) determining depth information relating to at least a point of each of the two or more inputs of the 2D facial image and (iii) constructing the 3D facial model in response to the determination of the depth information. In various embodiments, the step of constructing the 3D facial model can further include (iv) determining at least one parameter to detect authenticity of the facial image. In other words, the various example embodiments provide a method that can be used for face spoof detection. The method includes (i) feature acquisition, (ii) extraction, (iii) processing phase and then (iv) a liveness classification phase.

In the (i) feature acquisition, (ii) extraction and (iii) processing stages, a 3D facial model (i.e. a mathematical representation) of a person's face is generated. The generated 3D facial model can include more information (in x, y and z axes) as compared to a 2D facial image of the person. The system and method in accordance to various embodiments of the invention can construct a mathematical representation of the person's face by using two or more inputs of the 2D facial image (i.e. two or more images captured at different proximities, either at different object distances or different focal lengths, with one or more image sensors) in rapid succession. Further, it can also be appreciated that the two or more inputs captured at different distances are captured at different angles relative to the image capturing device. The two or more inputs of the 2D image obtained from the acquisition method as described above can be used in the (ii) extraction phase to obtain depth information (z axis) of the facial attributes as well as to capture other key facial attributes and geometric properties of the person's face.

In various embodiments, as will be described in more details below, the (ii) extraction phase can include determining depth information relating to at least a point (e.g. facial landmark point) of each of the two or more inputs of the 2D facial image. A mathematical representation of the person's face (i.e. 3D facial model) is then constructed, in (iii) processing stage, in response to the determination of the depth information obtained from the (ii) extraction phase. In various embodiments, the 3D facial model can comprise a set of feature vectors that form a basic facial configuration, where the feature vectors describe facial fiducial points of the person in a 3D scene. This allows for a mathematical quantification of depth values between each pair of points on the facial map.

In addition to construction of a basic facial configuration for a given face, a method to deduce the head orientation of the person (a.k.a. head pose) relative to the image sensor is also disclosed. That is, the person's head pose can change relative to the image sensor (e.g. if the image sensor is housed in a mobile device and the user shifts the mobile device around, or when the user shifts relative to a stationary input capturing device). The person's pose can change with rotation of the image sensor about the x, y and z axes, and the rotation is expressed using yaw, pitch and roll angles. If the image sensor is housed in a mobile device, the orientation of the mobile device can be determined from acceleration values (gravitational force) recorded by a motion sensor communicatively coupled with the device (e.g. an accelerometer housed in the mobile device) for each axis. Furthermore, the 3-dimensional orientation and position of the person head relative to the image sensor can be determined using facial feature locations and their relative geometric relationship, and can expressed in terms of yaw, pitch and roll angles relative to the pivot point (e.g. with the mobile device as a reference point, or a reference facial landmark point). The orientation information of the mobile device and that for the person's head pose are then used to determine the orientation and position of the mobile device relative to the person's head pose.

In (iv) the liveness classification phase, the depth feature vectors of the person (i.e. 3D facial model) and relative orientation information obtained, as described in the aforementioned paragraph, can be used in a classification process to provide an accurate prediction of the liveness of the face. In the liveness classification stage, the facial configuration (i.e. 3D facial model) as well as the spatial and orientation information of the mobile device and the person's head pose are fed into a neural network to detect the liveness of the face.

### Exemplary Embodiments

The example embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “associating”, “calculating”, “comparing”, “determining”, “forwarding”, “generating”, “identifying”, “including”, “inserting”, “modifying”, “receiving”, “replacing”, “scanning”, “transmitting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may include a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a computer effectively results in an apparatus that implements the steps of the preferred method.

In the example embodiments, use of the term ‘server’ may mean a single computing device or at least a computer network of interconnected computing devices which operate together to perform a particular function. In other words, the server may be contained within a single hardware unit or be distributed among several or many different hardware units.

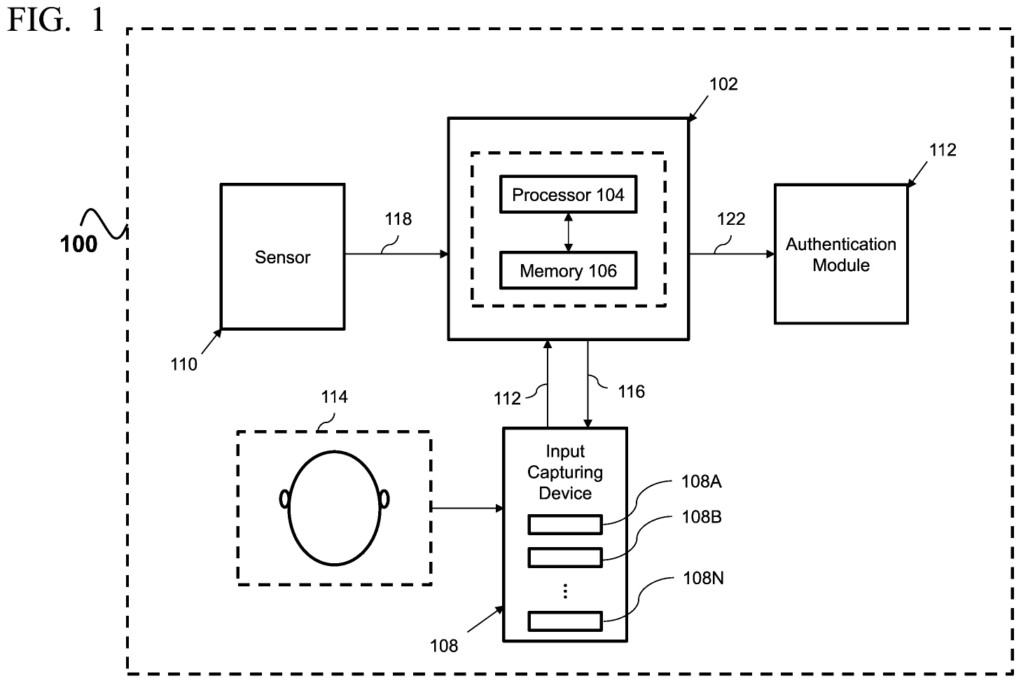

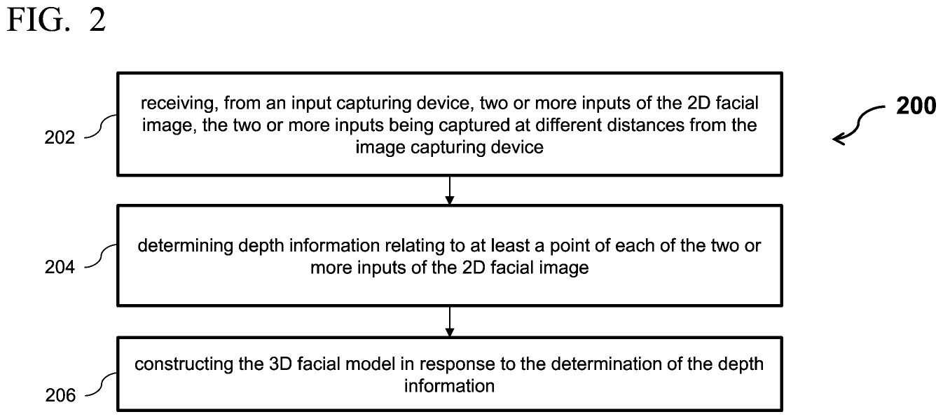

An exemplary embodiment of the server is shown in FIG. 1. FIG. 1 shows a schematic diagram of a server 100 for adaptively constructing a three-dimensional (3D) facial model based on two or more inputs of a two-dimensional (2D) facial image, in accordance with embodiments of the disclosure. The server 100 can be used to implement method 200 as shown in FIG. 2. The server 100 includes a processing module 102 comprising a processor 104 and memory 106. The server 100 also includes an input capturing device 108 communicative coupled with processing module 102 and configured to transmit two or more inputs 112 of the 2D facial image 114 to the processing module 102. The processing module 102 is also configured to control input capturing device 108 through one or more instructions 116. The input capturing device 108 can include one or more image sensors 108A, 108B . . . 108N. The one or more image sensors 108A, 108B . . . 108N may include image sensors with different focal lengths, so that two or more inputs of the 2D facial image 114 of the person can be captured at different distances from the image capturing device without relative movement between the image capturing device and the person. In various embodiments of the invention, the image sensors can include visible light sensors and infrared sensors. It can also be appreciated that if the input capturing device 108 includes only a single image sensor, relative movement between the image capturing device and the person may be required to capture two or more inputs at different distances.

The processing module 102 can be configured to receive from the input capturing device 108, the two or more inputs 112 of the 2D facial image 114 and determine depth information relating to at least a point of each of the two or more inputs 112 of the 2D facial image 114 and construct a 3D facial model in response to the determination of the depth information.

The server 100 also includes sensor 110 communicative coupled to the processing module 102. The sensor 110 can be one or more motion sensors configured to detect and provide acceleration values 118 to the processing module 102. The processing module 102 is also communicatively coupled with decision module 112. The decision module 112 can be configured to receive, from the processing module 102, information associated with the depth feature vectors of the person (i.e. 3D facial model) and the orientation and position of the image capturing device relative to the person's head pose, and can be configured to execute a classification algorithm with the information received to provide a prediction of the liveness of the face.

### Implementation Details—System Design

In various embodiments of the invention, the system for face liveness detection can comprise two sub-systems, namely a capturing sub-system and decision sub-system. The capturing sub-system can include the input capturing device 108 and the sensor 110. The decision sub-system can include processing module 102 and decision module 112. The capturing sub-system can be configured to receive data from image sensors (e.g. RGB cameras and/or infrared cameras) and one or more motion sensors. The decision subsystem can be configured to provide a decision for liveness detection and facial verification based on information provided by the capturing sub-system.

### Implementation Details—Liveness decision process

The liveness of a face can be distinguished from spoofed images and/or videos if a number of stereo facial images are captured at different distances relative to a input capturing device. The liveness of a face can also be distinguished from spoofed images and/or videos based on certain facial features characteristic of a real face. Facial features in facial images from a real face that is close to the image sensor would appear relatively larger than facial features in images from a real face that are far from the image sensor. This is due to the perspective distortion caused by the distance using an image sensor with, for example, a wide angle lens. The example embodiments can then leverage on these distinct differences to classify a facial image as real or spoofed. There is also disclosed a method of training a neural network to classify the 3D facial model into real and spoofed, including identifying a series of facial landmarks (or distinctive facial features) at far and near distances with respect to different camera view angles.

### Implementation Details—Liveness Decision Data Flow—Data Capturing

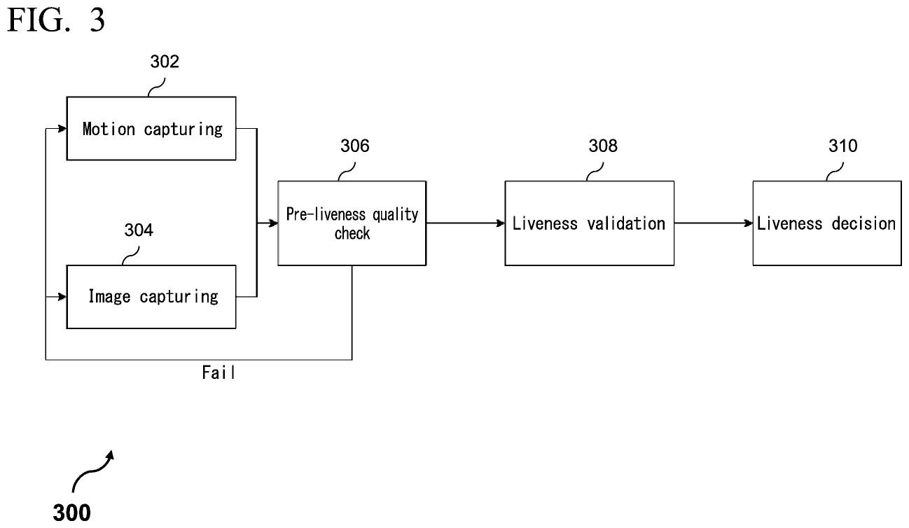

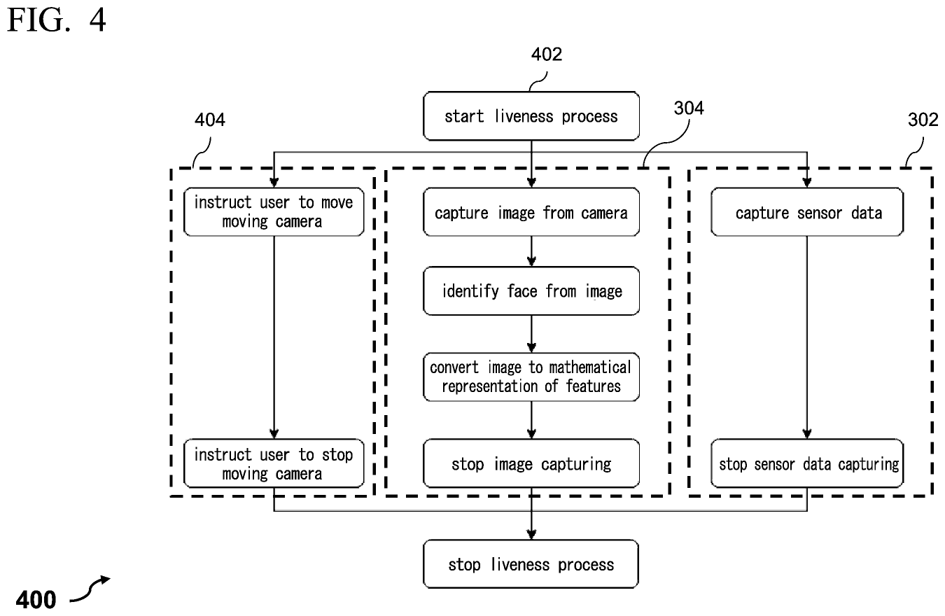

FIG. 3 shows a sequence diagram 300 for determining an authenticity of a facial image, in accordance with embodiments of the invention. The sequence diagram 300 is also known as a liveness decision data flow process. FIG. 4 shows a sequence diagram 400 (also known as liveness process 400) for obtaining motion sensor information and image sensor information, in accordance with embodiments of the invention. FIG. 4 is described with reference to the sequence diagram 300 of FIG. 3. The liveness process 400 as well as the liveness decision data flow process 300 starts with motion capturing 302 of two or more inputs of the 2D facial image, the two or more inputs being captured at different distances from the image capturing device, as well as the capture 304 of motion information from one or more motion sensors. In various embodiments, the two or more inputs can also be captured at different angles from the image capturing device. The image capturing device can be the input capturing device 108 of the server 100, and the one or more motion sensors can be sensor 110 of the server 100. In various embodiments of the invention, the server 100 can be a mobile device. The information can be transmitted to the processing module 102, and the processing module 102 can be configured to execute pre-liveness quality check to ensure that the information collected is of good quality (luminosity, sharpness, etc.) before transmitting the information to the decision module 112. In embodiments of the invention, sensor data, including posture of the device as well and acceleration of the device, can also be captured in capturing process 304. The data can help to determine whether a user has correctly responded to a liveness challenge. For example, the user's head can be aligned relatively center to the projection of an image sensor of the input capturing device, and the subject's head position, roll, pitch, yaw, should be proportionally straight to the camera. A series of images is captured starting from the far bounding box with gradually moving towards the near bounding box.

### Implementation Details—Liveness Decision Data Flow—Pre-liveness Filtering

A pre-liveness quality check 306 can include checking the luminance on face and background of the two or more inputs, sharpness of face, gaze of the user to sure that the data collected is of good quality and is not captured without the user's attention. The captured images can be sorted by eye distance (distance between left eye and right eye), and images that contains similar eye distances are removed, the eye distance being indicative of the proximity of the facial image relative to the input capturing device. Other preprocessing methods may be applied during the data collection, such as, gaze detection, blurriness detection, or brightness detection. This is to ensure that the captured images are free from environment distortion, noises or disturbances introduced due to human error.

### Implementation Details—Liveness Decision Data Flow—Liveness Challenge

When a face is captured by the input capturing device 108, the information is generally projected perceptively onto a planar 2D image sensor (e.g. a CCD or CMOS sensor). Projection of a 3D object (e.g. a face) onto a planar 2D image sensor can allow conversion of a 3D face into 2D mathematical data for facial recognition and liveness detection. However, the conversion can result in a loss of depth information. To retain the depth information, multiple frames with different distances/angles to the converging point will be captured and used collectively to differentiate a 3D facial subject from 2D spoofing. In various embodiments of the invention, there can be included a liveness challenge 404, where the user is prompted to move their device (translationally and/or rotationally) relative to the user's face to as to allow for a change in perspective. The user's movement of the device is not restricted during enrollment or verification, as long as the user manages to fit their face within the frame of the image sensor.

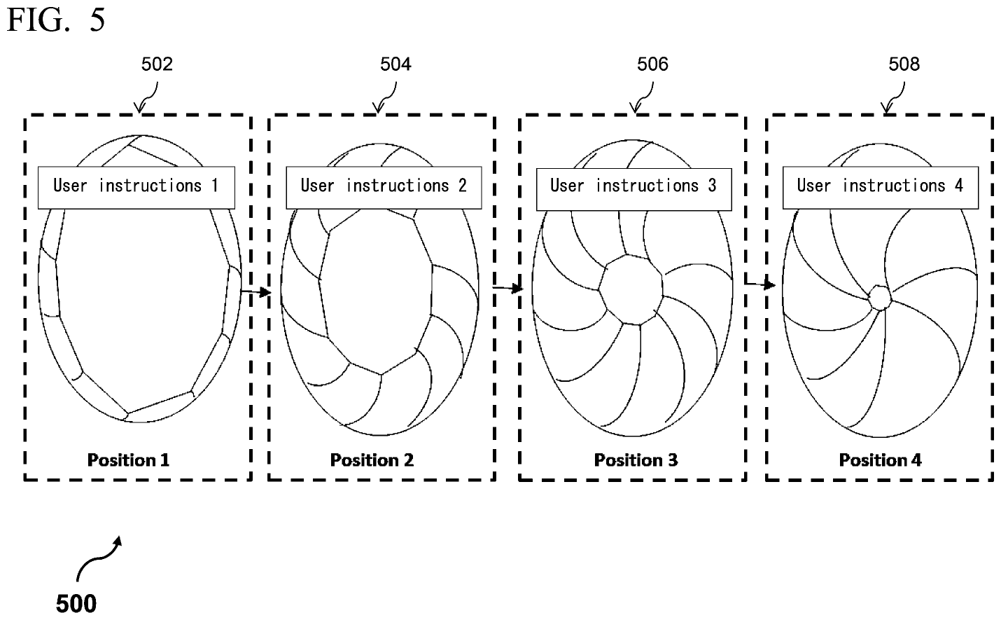

FIG. 5 shows exemplary screenshots 500 seen by a user during a liveness challenge 404, in accordance with embodiments of the invention. FIG. 5 shows transitions of a user interface shown on a display screen (e.g. a screen of an exemplary mobile device) as two or more images at different distances are being captured by the input capturing device, as the user is performing authentication. In the exemplary embodiment, the user interface can adopt a visual skeuomorph and can show a camera shutter diaphragm (see FIG. 5). The user interface is motion based and can mimic a camera shutter in action. User instructions can be displayed on the screen within a reasonable amount of time for each positon (screenshots 502, 504, 506, 508) to improve usability. In screenshot 502, a “fully opened” aperture for capturing an image of the face positioned at a distance d1 from the camera of the mobile device is disclosed. In screenshot 502, the user is prompted to position his face close to the image sensor so that the face can be captured at close range, and the face is shown entirely within the aperture of the simulated diaphragm. In screenshot 504, a “half-opened” aperture for capturing an image of the face positioned at a distance d2 from the image sensor. In screenshot 504, the user is prompted to position his face a little further from the image sensor, so that the face is shown within the “half-opened” aperture of the simulated diaphragm, where d1<d2.

In screenshot 506, the user is prompted to position his face even further from the image sensor so that the face can be captured at a further range. In screenshot 506, a “quarter-opened” aperture for capturing an image of the face positioned at a distance d3 from the image sensor, where d1<d2<d3. In screenshot 508, the user is presented with a “closed aperture” indicating all the images of the person have been captured and that the images are being processed.

In various embodiments of the invention, control of the transitions of the user interface (i.e. the control of the image capturing device) can be based in response to a change identified between two or more inputs of the 2D facial image. In an embodiment, the change can be a difference between a first x-axis distance and a second x-axis distance, the first x-axis distance and the second x-axis distance representing the distance in a x-axis direction between two reference points, the two reference points identified in a first and second of the two or more inputs. In an alternate embodiment, the change can be a difference between a first y-axis distance and a second y-axis distance, the first y-axis distance and the second y-axis distance representing the distance in a y-axis direction between two reference points, the two reference points identified in a first and second of the two or more inputs. In other words, control of the image capturing device, so as to capture two or more inputs of the 2D facial image, can be based in response to the difference between at least one of (i) the first x-axis distance and the second x-axis distance and (ii) the first y-axis distance and the second y-axis distance. The above-mentioned control method can also be used to cease further inputs of the 2D facial image. In an exemplary embodiment, the first of the two reference points can be a facial landmark point associated with an eye of the user, and the second of the two reference points can be another facial landmark point associated with other eye of the user.

In various embodiments, the image sensors can include visible light sensors and infrared sensors. Where the input capturing device includes one or more image sensors, each of the one or more image sensors can include one or more of a group of photographic lenses including wide angle lens, telescopic lens, zoom lens with variable focal lengths or normal lens. It can also be appreciated that the lenses in front of the image sensors may be interchangeable (i.e. the input capturing device can swap lenses positioned in front of the image sensors). For input capturing devices with one or more image sensors with fixed lenses, the first lens can have a focal length different from that of the second and subsequent lenses. Advantageously movement of input capturing device with one or more image sensors relative to the user may be omitted when capturing two or more inputs of the facial image. That is, the system can be configured to automatically capture two or more inputs of the facial image of the person at different distances, since two or more inputs of the 2D facial image can be captured at the different focal lengths using different lens (and image sensors), without relative movement between the input capturing device and the user. In various embodiments, the user interface transition as described above can be synchronized with the input capture at different focal lengths.

### Implementation Details—Liveness Decision Data Flow—Data processing

The step of (ii) determining depth information relating to at least a point of each of the two or more inputs of the 2D facial image and (iii) constructing the 3D facial model in response to the determination of the depth information shown in FIG. 2 and mentioned in the preceding paragraphs will be described in more detail. The two or more inputs of the 2D facial image, captured at different distances from the image capturing device, will be processed to determine depth information relating to at least a point of each of the two or more inputs of the 2D facial image. Processing of the two or more inputs of the 2D facial image can be performed by the processing module 102 of FIG. 1. The data processing can include data filtering, data normalization and data transformation. In data filtering, images captured with motion blurriness, focus blurriness, or surplus data which is not important or required for liveness detection can be removed. Data normalization can remove biases that are introduced in the data due to hardware differences between different input capturing devices. In data transformation, data is transformed into the feature vectors that describe facial fiducial points of the person in 3 dimensional scene, and can involve combination of features and attributes, as well as computation of the geometric properties of the person's face. Data processing can also eliminate some of the data noises from differences resulting from, for example, configuration of the image sensors of the input capturing devices. Data processing can also enhance focus on facial features which are used to differentiate the perspective distortion of 3D faces from 2D spoof faces.

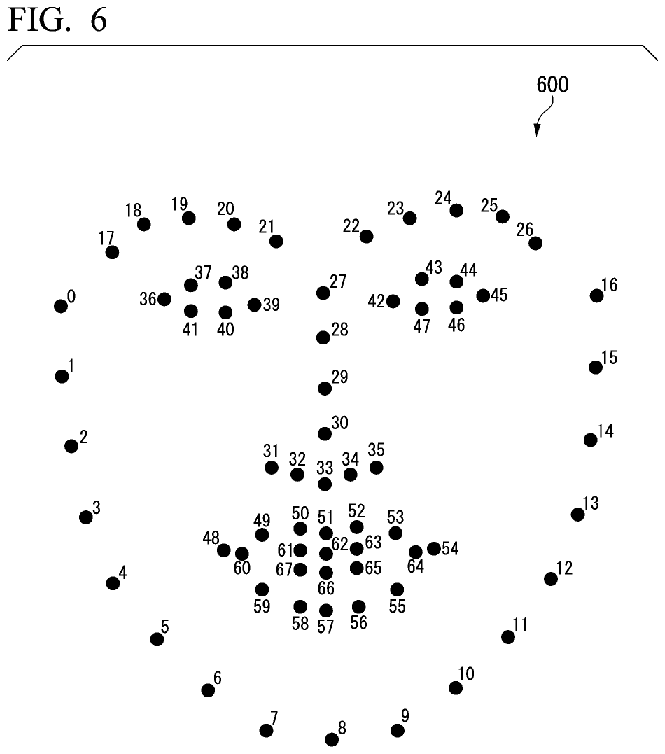

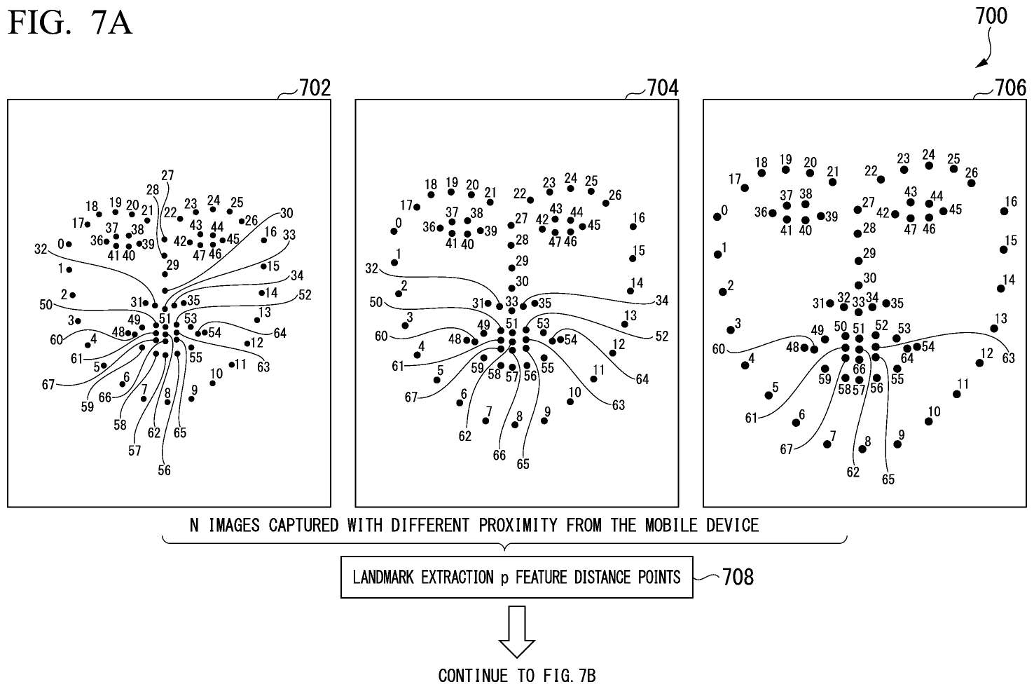

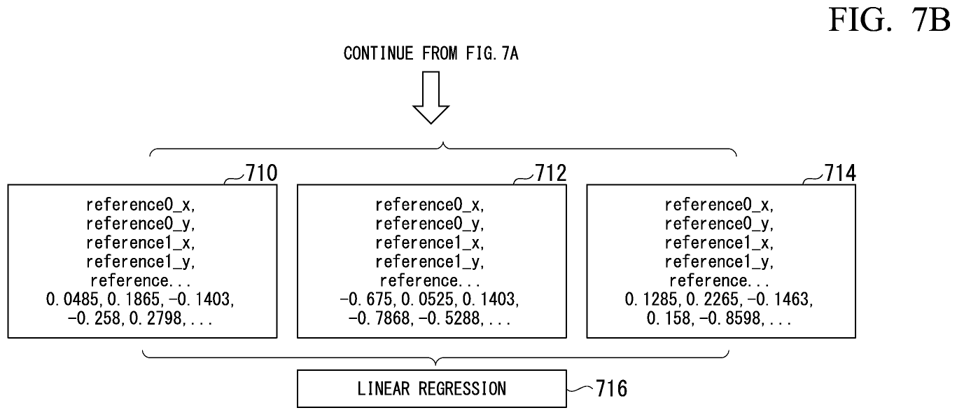

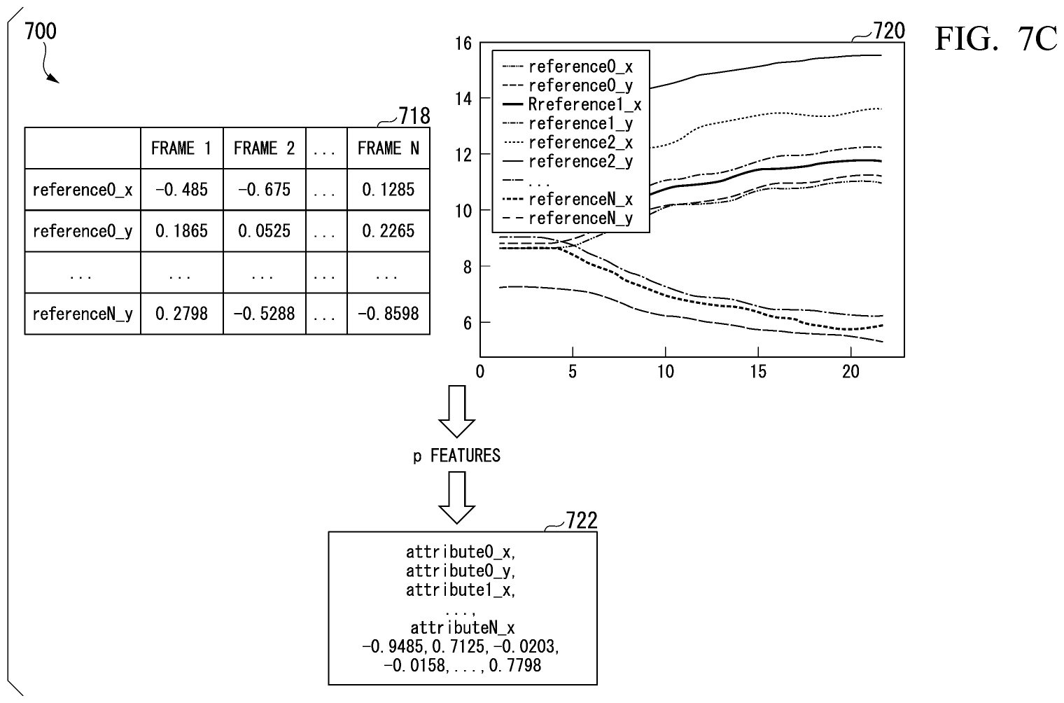

FIGS. 7A and 7B show a sequence diagram for constructing a 3D facial model, in accordance with embodiments of the invention. In embodiments of the invention, the 3D facial model is constructed in response to a determination of depth information based on facial landmark points associated with the two-dimensional facial image. The determination of depth information relating to at least a point of each of the two or more inputs of the 2D facial image (i.e. extraction of feature information from the captured images) are also described with reference to FIGS. 7A to 7C. As shown in FIGS. 7A and 7B, each of the two or more inputs of the 2D facial image images 702, 704, 706 are first extracted and a selected set of facial landmark points are calculated with respect to the facial bounding box. An exemplary set of facial landmark points 600 is shown in FIG. 6. In embodiments of the invention, the facial bounding boxes can have the same aspect ratio throughout the series of inputs to improve accuracy and speed of the facial landmark extraction. In facial landmark extraction 708, tracking points is projected to the image's coordinate system with respect to the facial bounding box width and height. Among the set of landmark points as shown in FIG. 6, a reference facial landmark point, is used for distance calculation of all other facial landmark points. These distances will be served as the facial image features at the end. For each facial landmark point, the x and y distance are calculated by taking the absolute value of difference between the x and y point of the particular facial landmark point and the reference facial landmark point. The total output of a single facial image landmark calculation would be a series of distances between the reference facial landmark point and each of the facial landmark points other than the reference facial landmark point. The output 710, 712, 714 for each of the two or more inputs 702, 704, 706 is shown in FIGS. 7A and 7B. Thus, the outputs 710, 712, 714 are a set of x distances of the landmark points to the reference point and a set of y distance of the landmark points to the reference point. A sample pseudo code for the implementation is as shown below

for each landmark in facial landmarks except referencepoint do

x_distance=|landmark.x−referencepoint.x|

y_distance=|landmark.y−referencepoint.y|

In other words, the step of determining depth information relating to at least a point of each of the two or more inputs of the 2D facial image comprises (a) determining a first x-axis and a first y-axis distance between two reference points (i.e. the reference facial landmark point and one of the facial landmark points other than the reference facial landmark point) in a first of the two or more inputs, the first x-axis distance and the first y-axis distance representing the distance between the two reference points in a x-axis direction and a y-axis direction, respectively, and (b) determining a second x-axis and a second y-axis distance between the two reference points in a second of the two or more inputs, the second x-axis distance and the second y-axis distance representing the distance between the two reference points in a x-axis direction and a y-axis direction, respectively. The steps are repeated for each of the facial landmark points (i.e. subsequent reference points) and for subsequent inputs of the 2D facial image. Accordingly, as facial landmark points are determined and distances between the facial landmark points and a reference facial landmark point are calculated, the outputs of the determination 710, 712, 714 are a series of N frames with a set of feature points of landmark (say p), i.e. N frames of images would produce a total of N*p feature points 718 (see FIG. 7C). The N*p feature points 718 are also shown in graph 720, which shows how the x-axis distances and y-axis distances varies across the two or more inputs of the 2D facial image (shown in the x-axis of the graph 720).

The outputs 710, 712, 714 (shown in table 718 and graph 720) can be used to obtain a resultant list of depth feature points by determining a difference between at least one of (i) the first x-axis distance and the second x-axis distance and (ii) the first y-axis distance and the second y-axis distance so as to determine the depth information. In an exemplary embodiment, the depth information can be obtained using linear regression 716. Specifically, the outputs 710, 712, 714 are reduced using linear regression 716, where each feature point is fitted to a line using linear regression and the slope of the line joining a feature point pair is retrieved. The output is a series of attribute values 722. Small moving average or other smoothing function can be used to smooth the series of feature points before fitting into the linear regression. Thus, the facial attribute value 722 of the 2D facial image can be determined, and the 3D facial model can be constructed in response to the determination of the facial attribute 722.

Moreover, in various embodiments of the invention, camera angle data, obtained from motion sensors 110 (e.g. accelerometer and gyroscope) can be added as feature points. The camera angle information can be obtained by calculating the gravity acceleration from the accelerometer. The accelerometer sensor data can include gravity and other device acceleration information. Only the gravitational acceleration (which may be in the x,y,z axis, with value between −9.81 to 9.81) is considered to determine the angle of the device. In an embodiment, three rotation values (roll, pitch, and yaw) are retrieved for each frame, and the average of the values from the frames are calculated and added as the feature point. That is, the feature point consists of just three averaged values. In another embodiment, the average is not calculated, and the feature point consists of rotation values (roll, pitch, and yaw) for each frame. That is, the feature point consists of n frames*(roll, pitch, and yaw) values. Thus, rotational information of the 2D facial image can be determined, and the 3D facial model can be constructed in response to the determination of the rotational information.

### Implementation Details—Liveness Decision Data Flow—Classification Process

The depth feature vectors of the person and the average of the three rotation values, roll, pitch, and yaw, are then subject to a classification process to obtain an accurate prediction of the liveness of the face. In the classification process, the basic facial configuration and the spatial and orientation information of the mobile device and the person's head pose are fed into a deep-learning model to detect the liveness of the face.

Accordingly, a system and method for face liveness detection is disclosed. A deep learning based spoof face detection mechanism is employed to detect liveness of a face and to ascertain the real presence of an authenticated user. In embodiments of the invention, there are two main phases in the face liveness detection mechanism. The first phase involves data capturing, pre-liveness filtering, liveness challenge, data processing and feature transformation. In this phase, a basic facial configuration from set of separate inputs of a 2D facial image is captured at different proximities from an image sensor (e.g. a camera of a mobile device) in rapid succession, where this basic facial configuration consists of a set of feature vectors that allows for a mathematical quantification of depth values between each pair of points on the facial map. In addition to constructing a basic facial configuration for the face, the head orientation of the person relative to a view of the mobile device's camera is also determined from the gravitational values for x, y and z axis of the mobile device and the orientation of the person's head pose. The second phase is the classification process, where the basic facial configuration, along with relative orientation information between the mobile device and the head pose of the user are fed into a classification process for face liveness prediction and ascertain the real presence of the authenticated user before granting the user access to his or her account. Thus, in summary, That is, a 3D facial configuration from a set of separate face images can captured at different proximities from the camera of the mobile device. The 3D facial configuration, as well as optionally, relative orientation information between the mobile device and the head pose of the user, can be used as inputs to a classification process for face liveness prediction. The mechanism can deliver a high assurance and reliable solution that is capable of effectively countering a plethora of face spoofing techniques.

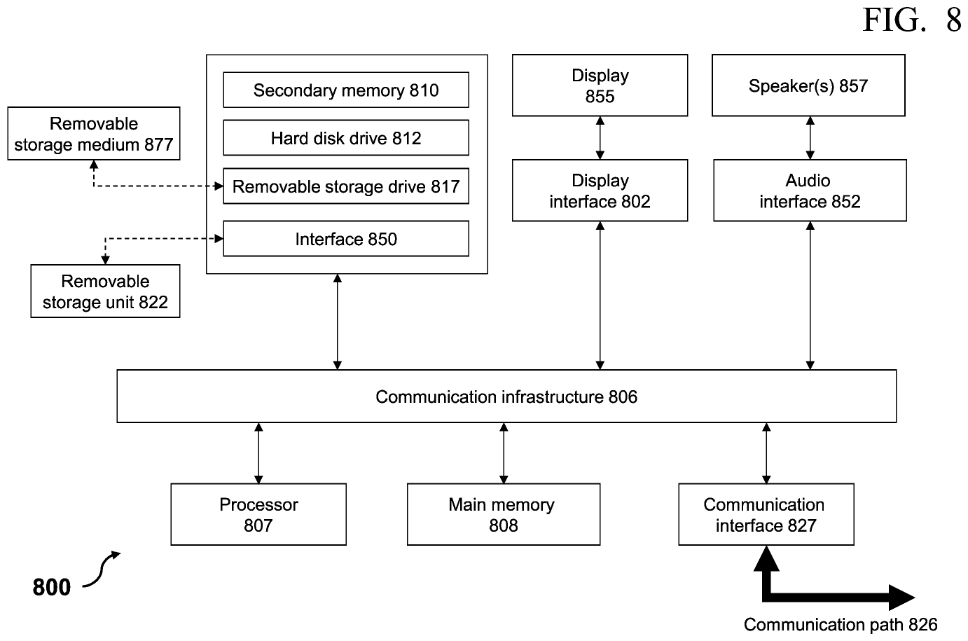

FIG. 8 depicts an exemplary computing device 800, hereinafter interchangeably referred to as a computer system 800, where one or more such computing devices 800 may be used to execute the method 200 of FIG. 2. One or more components of the exemplary computing device 800 can also be used to implement the system 100, and the input capturing device 108. The following description of the computing device 800 is provided by way of example only and is not intended to be limiting.

As shown in FIG. 8, the example computing device 800 includes a processor 807 for executing software routines. Although a single processor is shown for the sake of clarity, the computing device 800 may also include a multi-processor system. The processor 807 is connected to a communication infrastructure 806 for communication with other components of the computing device 800. The communication infrastructure 806 may include, for example, a communications bus, cross-bar, or network.

The computing device 800 further includes a main memory 808, such as a random access memory (RAM), and a secondary memory 810. The secondary memory 810 may include, for example, a storage drive 812, which may be a hard disk drive, a solid state drive or a hybrid drive and/or a removable storage drive 817, which may include a magnetic tape drive, an optical disk drive, a solid state storage drive (such as a USB flash drive, a flash memory device, a solid state drive or a memory card), or the like. The removable storage drive 817 reads from and/or writes to a removable storage medium 877 in a well-known manner. The removable storage medium 877 may include magnetic tape, optical disk, nonvolatile memory storage medium, or the like, which is read by and written to by removable storage drive 817. As will be appreciated by persons skilled in the relevant art(s), the removable storage medium 877 includes a computer readable storage medium comprising stored therein computer executable program code instructions and/or data.

In an alternative implementation, the secondary memory 810 may additionally or alternatively include other similar means for allowing computer programs or other instructions to be loaded into the computing device 800. Such means can include, for example, a removable storage unit 822 and an interface 850. Examples of a removable storage unit 822 and interface 850 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 822 and interfaces 850 which allow software and data to be transferred from the removable storage unit 822 to the computer system 800.

The computing device 800 also includes at least one communication interface 827. The communication interface 827 allows software and data to be transferred between computing device 800 and external devices via a communication path 826. In various embodiments of the inventions, the communication interface 827 permits data to be transferred between the computing device 800 and a data communication network, such as a public data or private data communication network. The communication interface 827 may be used to exchange data between different computing devices 800 which such computing devices 800 form part an interconnected computer network. Examples of a communication interface 827 can include a modem, a network interface (such as an Ethernet card), a communication port (such as a serial, parallel, printer, GPIB, IEEE 1394, RJ45, USB), an antenna with associated circuitry and the like. The communication interface 827 may be wired or may be wireless. Software and data transferred via the communication interface 527 are in the form of signals which can be electronic, electromagnetic, optical or other signals capable of being received by communication interface 527. These signals are provided to the communication interface via the communication path 526.

As shown in FIG. 8, the computing device 800 further includes a display interface 802 which performs operations for rendering images to an associated display 850 and an audio interface 852 for performing operations for playing audio content via associated speaker(s) 857.

As used herein, the term “computer program product” may refer, in part, to removable storage medium 877, removable storage unit 822, a hard disk installed in storage drive 812, or a carrier wave carrying software over communication path 826 (wireless link or cable) to communication interface 827. Computer readable storage media refers to any non-transitory, non-volatile tangible storage medium that provides recorded instructions and/or data to the computing device 800 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 800. Examples of transitory or non-tangible computer readable transmission media that may also participate in the provision of software, application programs, instructions and/or data to the computing device 800 include radio or infra-red transmission channels as well as a network connection to another computer or networked device, and the Internet or Intranets including e-mail transmissions and information recorded on Websites and the like.

The computer programs (also called computer program code) are stored in main memory 808 and/or secondary memory 810. Computer programs can also be received via the communication interface 827. Such computer programs, when executed, enable the computing device 800 to perform one or more features of embodiments discussed herein. In various embodiments, the computer programs, when executed, enable the processor 807 to perform features of the above-described embodiments. Accordingly, such computer programs represent controllers of the computer system 800.

Software may be stored in a computer program product and loaded into the computing device 800 using the removable storage drive 817, the storage drive 812, or the interface 850. The computer program product may be a non-transitory computer readable medium. Alternatively, the computer program product may be downloaded to the computer system 800 over the communication path 826. The software, when executed by the processor 807, causes the computing device 800 to perform the necessary operations to execute the method 200 as shown in FIG. 2.

It is to be understood that the embodiment of FIG. 8 is presented merely by way of example to explain the operation and structure of the system 800. Therefore, in some embodiments one or more features of the computing device 800 may be omitted. Also, in some embodiments, one or more features of the computing device 800 may be combined together. Additionally, in some embodiments, one or more features of the computing device 800 may be split into one or more component parts.

It will be appreciated that the elements illustrated in FIG. 8 function to provide means for performing the various functions and operations of the system as described in the above embodiments.

When the computing device 800 is configured to realise the system 100 to adaptively construct a three-dimensional (3D) facial model based on a two-dimensional (2D) facial image, the system 100 will have a non-transitory computer readable medium comprising stored thereon an application which when executed causes the system 100 to perform steps comprising: (i) receive, from an input capturing device, two or more inputs of the 2D facial image, the two or more inputs being captured at different distances from the image capturing device, (ii) determine depth information relating to at least a point of each of the two or more inputs of the 2D facial image, and (iii) construct the 3D facial model in response to the determination of the depth information.

It will be appreciated by a person skilled in the art that numerous variations and/or modifications may be made to the example embodiments as shown in the specific embodiments without departing from the spirit or scope of the invention as broadly described. The present embodiments are, therefore, to be considered in all respects to be illustrative and not restrictive.

The exemplary embodiments described above may also be described entirely or in part by the following supplementary notes, without being limited to the following.

### Supplementary Note 1

A server for adaptively constructing a three-dimensional (3D) facial model based on two or more inputs of a two-dimensional (2D) facial image, the server comprising:

at least one processor; and

at least one memory including computer program code;

the at least one memory and the computer program code configured to, with the at least one processor, cause the server at least to:

receive, from an input capturing device, the two or more inputs of the 2D facial image, the two or more inputs being captured at different distances from the image capturing device;

determine depth information relating to at least a point of each of the two or more inputs of the 2D facial image; and construct the 3D facial model in response to the determination of the depth information.

### Supplementary Note 2

The server according to supplementary note 1, wherein the at least one memory and the computer program code are configured to, with the at least one processor, cause the server to:

determine a first x-axis and a first y-axis distance between two reference points in a first of the two or more inputs, the first x-axis distance and the first y-axis distance representing the distance between the two reference points in a x-axis direction and a y-axis direction, respectively; and

determine a second x-axis and a second y-axis distance between the two reference points in a second of the two or more inputs, the second x-axis distance and the second y-axis distance representing the distance between the two reference points in a x-axis direction and a y-axis direction, respectively.

### Supplementary Note 3

The server according to supplementary note 2, wherein the at least one memory and the computer program code are configured to, with the at least one processor, cause the server to:

determine a difference between at least one of (i) the first x-axis distance and the second x-axis distance and (ii) the first y-axis distance and the second y-axis distance so as to determine the depth information.

### Supplementary Note 4

The server according to supplementary note 1, wherein the at least one memory and the computer program code are configured to, with the at least one processor, cause the server to further:

control the image capturing device to capture the two or more inputs at different distances and angles relative to the image capturing device.

### Supplementary Note 5

The server according to supplementary note 1, wherein the at least one memory and the computer program code are configured to, with the at least one processor, cause the server to further:

determine a facial attribute of the 2D facial image, wherein the 3D facial model is constructed in response to the determination of the facial attribute.

### Supplementary Note 6

The server according to supplementary note 1, wherein the at least one memory and the computer program code are configured to, with the at least one processor, cause the server to further:

determine rotational information of the 2D facial image, wherein the 3D facial model is constructed in response to the determination of the rotational information.

### Supplementary Note 7

The server according to supplementary note 1, wherein the at least one memory and the computer program code are configured to, with the at least one processor, cause the server to further:

control the image capturing device in response to the difference between at least one of (i) the first x-axis distance and the second x-axis distance and (ii) the first y-axis distance and the second y-axis distance.

### Supplementary Note 8

The server according to supplementary note 7, wherein the at least one memory and the computer program code are configured to, with the at least one processor, cause the server to further:

control the image capturing device to cease taking a further input of the 2D facial image.

### Supplementary Note 9

The server according to supplementary note 1, wherein the at least one memory and the computer program code are configured to, with the at least one processor, cause the server to:

determine at least one parameter to detect authenticity of the facial image.

### Supplementary Note 10

A method for adaptively constructing a three-dimensional (3D) facial model based on two or more inputs of a two-dimensional (2D) facial image, the method comprising:

receiving, from an input capturing device, the two or more inputs of the 2D facial image, the two or more inputs being captured at different distances from the image capturing device;

determining depth information relating to at least a point of each of the two or more inputs of the 2D facial image; and

constructing the 3D facial model in response to the determination of the depth information.

### Supplementary Note 11

The method according to supplementary note 10, wherein the step of determining depth information relating to at least a point of each of the two or more inputs of the 2D facial image comprises:

determining a first x-axis and a first y-axis distance between two reference points in a first of the two or more inputs, the first x-axis distance and the first y-axis distance representing the distance between the two reference points in a x-axis direction and a y-axis direction, respectively; and

determining a second x-axis and a second y-axis distance between the two reference points in a second of the two or more inputs, the second x-axis distance and the second y-axis distance representing the distance between the two reference points in a x-axis direction and a y-axis direction, respectively.

### Supplementary Note 12

The method according to supplementary note 11, wherein the step of determining depth information relating to at least a point of each of the two or more inputs of the 2D facial image further comprises:

determining a difference between at least one of (i) the first x-axis distance and the second x-axis distance and (ii) the first y-axis distance and the second y-axis distance so as to determine the depth information.

### Supplementary Note 13

The method according to supplementary note 10, wherein the two or more inputs are captured at different distance and angles relative to the image capturing device.

### Supplementary Note 14

The method according to supplementary note 10, further comprising: determining a facial attribute of the 2D facial image, wherein the 3D facial model is constructed in response to the determination of the facial attribute.

### Supplementary Note 15

The method according to supplementary note 10, further comprising: determining rotational information of the 2D facial image, wherein the 3D facial model is constructed in response to the determination of the rotational information.

### Supplementary Note 16

The method according to supplementary note 10, further comprising:

controlling the image capturing device in response to the difference between at least one of (i) the first x-axis distance and the second x-axis distance and (ii) the first y-axis distance and the second y-axis distance so as to capture the two or more inputs of the 2D facial image.

### Supplementary Note 17

The method according to supplementary note 16, further comprising:
controlling the image capturing device to cease taking a further input of the 2D facial image.

### Supplementary Note 18

The method according to supplementary note 10, where the step of constructing the 3D facial model comprises:

determining at least one parameter to detect authenticity of the facial image.

This application is based upon and claims the benefit of priority from Singapore Patent Application No. 10201902889V, filed Mar. 29, 2019, the disclosure of which is incorporated herein in its entirety.

1. A server for adaptively constructing a three-dimensional (3D) facial model based on two or more inputs of a two-dimensional (2D) facial image, the server comprising:
at least one processor; and
at least one memory including computer program code;
the at least one memory and the computer program code configured to, with the at least one processor, cause the server at least to:
receive, from an input capturing device, the two or more inputs of the 2D facial image, the two or more inputs being captured at different distances from the image capturing device;
determine depth information relating to at least a point of each of the two or more inputs of the 2D facial image; and
construct the 3D facial model in response to the determination of the depth information.

2. The server according to claim 1, wherein the at least one memory and the computer program code are configured to, with the at least one processor, cause the server to:
determine a first x-axis and a first y-axis distance between two reference points in a first of the two or more inputs, the first x-axis distance and the first y-axis distance representing the distance between the two reference points in a x-axis direction and a y-axis direction, respectively; and
determine a second x-axis and a second y-axis distance between the two reference points in a second of the two or more inputs, the second x-axis distance and the second y-axis distance representing the distance between the two reference points in a x-axis direction and a y-axis direction, respectively.

3. The server according to claim 2, wherein the at least one memory and the computer program code are configured to, with the at least one processor, cause the server to:
determine a difference between at least one of (i) the first x-axis distance and the second x-axis distance and (ii) the first y-axis distance and the second y-axis distance so as to determine the depth information.

4. The server according to claim 1, wherein the at least one memory and the computer program code are configured to, with the at least one processor, cause the server to further:
control the image capturing device to capture the two or more inputs at different distances and angles relative to the image capturing device.

5. The server according to claim 1, wherein the at least one memory and the computer program code are configured to, with the at least one processor, cause the server to further:
determine a facial attribute of the 2D facial image, wherein the 3D facial model is constructed in response to the determination of the facial attribute.

6. The server according to claim 1, wherein the at least one memory and the computer program code are configured to, with the at least one processor, cause the server to further:
determine rotational information of the 2D facial image, wherein the 3D facial model is constructed in response to the determination of the rotational information.

7. The server according to claim 1, wherein the at least one memory and the computer program code are configured to, with the at least one processor, cause the server to further:
control the image capturing device in response to the difference between at least one of (i) the first x-axis distance and the second x-axis distance and (ii) the first y-axis distance and the second y-axis distance.

8. The server according to claim 7, wherein the at least one memory and the computer program code are configured to, with the at least one processor, cause the server to further:
control the image capturing device to cease taking a further input of the 2D facial image.

9. The server according to claim 1, wherein the at least one memory and the computer program code are configured to, with the at least one processor, cause the server to:
determine at least one parameter to detect authenticity of the facial image.

10. A method for adaptively constructing a three-dimensional (3D) facial model based on two or more inputs of a two-dimensional (2D) facial image, the method comprising:
receiving, from an input capturing device, the two or more inputs of the 2D facial image, the two or more inputs being captured at different distances from the image capturing device;
determining depth information relating to at least a point of each of the two or more inputs of the 2D facial image; and
constructing the 3D facial model in response to the determination of the depth information.

11. The method according to claim 10, wherein the step of determining depth information relating to at least a point of each of the two or more inputs of the 2D facial image comprises:
determining a first x-axis and a first y-axis distance between two reference points in a first of the two or more inputs, the first x-axis distance and the first y-axis distance representing the distance between the two reference points in a x-axis direction and a y-axis direction, respectively; and
determining a second x-axis and a second y-axis distance between the two reference points in a second of the two or more inputs, the second x-axis distance and the second y-axis distance representing the distance between the two reference points in a x-axis direction and a y-axis direction, respectively.

12. The method according to claim 11, wherein the step of determining depth information relating to at least a point of each of the two or more inputs of the 2D facial image further comprises:
determining a difference between at least one of (i) the first x-axis distance and the second x-axis distance and (ii) the first y-axis distance and the second y-axis distance so as to determine the depth information.

13. The method according to claim 10, wherein the two or more inputs are captured at different distance and angles relative to the image capturing device.

14. The method according to claim 10, further comprising:
determining a facial attribute of the 2D facial image, wherein the 3D facial model is constructed in response to the determination of the facial attribute.

15. The method according to claim 10, further comprising:
determining rotational information of the 2D facial image, wherein the 3D facial model is constructed in response to the determination of the rotational information.

16. The method according to claim 10, further comprising:
controlling the image capturing device in response to the difference between at least one of (i) the first x-axis distance and the second x-axis distance and (ii) the first y-axis distance and the second y-axis distance so as to capture the two or more inputs of the 2D facial image.

17. The method according to claim 16, further comprising:
controlling the image capturing device to cease taking a further input of the 2D facial image.

18. The method according to claim 10, where the step of constructing the 3D facial model comprises:
determining at least one parameter to detect authenticity of the facial image.
